(19) United States
(12) Patent Application Publication
(10) Pub. No.: US 2025/0388191 A1
(43) Pub. Date: Dec. 25, 2025

(54) Method and Device for Generating a Digital Access Key for a Motor Vehicle

(71) Applicant: Bayerische Motoren Werke Aktiengesellschaft, Muenchen (DE)

(72) Inventors: Matthias FINK, Muenchen (DE); Marco Hippler, Muenchen (DE); Daniel Kuelzer, Muenchen (DE)

(21) Appl. No.: 19/211,472

(22) Filed: May 19, 2025

(30) Foreign Application Priority Data
Jun. 20, 2024 (DE) 10 2024 117 478.1

(51) Int. Cl. B60R 25/24; G07C 9/00; H04L 9/40

(52) U.S. Cl. CPC B60R 25/241; G07C 9/00309; H04L 63/0442; B60R 2325/205; G07C 2009/00412; G07C 2009/00793

(57) ABSTRACT

A method and a device for generating a digital access key for a motor vehicle are disclosed. The method includes: generating a password by a first user terminal, wherein the first user terminal has a first digital access key for a motor vehicle, providing the password to a user of a second user terminal, encrypting the password in the first user terminal, providing the encrypted password to the second user terminal, generating a second digital access key for the motor vehicle in the second user terminal based on information from the first user terminal, providing the second digital access key and the encrypted password to the motor vehicle, decrypting the encrypted password in the motor vehicle, receiving a password entry from the user of the second user terminal in the motor vehicle, comparing the password entry with the decrypted password in the motor vehicle and providing vehicle functions if the password entry matches the decrypted password.

### CROSS REFERENCE TO RELATED APPLICATION

This application claims priority under 35 U.S.C. § 119 from German Patent Application No. 10 2024 117 478.1, filed Jun. 20, 2024, the entire disclosure of which is herein expressly incorporated by reference.

### BACKGROUND AND SUMMARY OF THE INVENTION

The invention relates to a method and device for generating a digital access key for a motor vehicle.

For example, a system for data exchange between at least one vehicle and at least one mobile terminal is known from DE 10 2014 203 060 A1.

It is the object of the invention to specify an improved method and an improved device for generating a digital access key for a motor vehicle.

According to the invention, this object is achieved by the subject matter of the independent claims. Advantageous embodiments of the invention are the subject matter of the dependent claims and the description.

A method according to the invention for generating a digital access key for a motor vehicle, including the steps of generating a password by a first user terminal, wherein the first user terminal has a first digital access key for a motor vehicle, providing the password to a user of a second user terminal, encrypting the password in the first user terminal, providing the encrypted password to the second user terminal, generating a second digital access key for the motor vehicle in the second user terminal based on information from the first user terminal, providing the second digital access key and encrypted password to the motor vehicle, decrypting the encrypted password in the motor vehicle, receiving a password entry by the user of the second user terminal in the motor vehicle, comparing the password entry with the decrypted password in the motor vehicle and providing vehicle functions if the password entry matches the decrypted password:

The method according to the invention serves to generate a further, second digital access key for the motor vehicle for a second user terminal in a particularly tamper-proof manner starting from a first user terminal which already has a digital access key for a motor vehicle. In particular, the method according to the invention provides two-factor authentication for the key generation.

Such a digital access key is used to unlock, to start the ignition and/or to deactivate an immobilizer of the motor vehicle. The digital access key can also enable and/or provide other functions in the motor vehicle. The digital access key is typically based on an asymmetric cryptosystem.

The first and second user terminals are devices that are set up for data processing. Both user terminals are designed to store and process a digital access key for at least one motor vehicle. The first and/or second user terminals are in the form of mobile phones, for example, in particular smartphones, phablets and/or tablets. Alternatively or additionally, the first and/or second user terminal can also be in the form of a so-called wearable, for example as a Fitbit, smart watch and/or smart glasses. In particular, the first and/or the second user terminal have a secure element, which provides such key management and/or key generation in a particularly secure manner.

Here the first user terminal already has a valid digital access key and is used to initiate or trigger the generation of another, second access key for the second user terminal.

According to the invention, a password is first generated by the first user terminal.

The password, which can also be referred to as a PIN, or personal identification number, is a combination of numbers and/or letters, which can also be referred to as alphanumeric. The password can be generated randomly by the first user terminal or based on user input.

In particular, the password is generated as part of a generation process for another digital access key, which is triggered by a user of the first user terminal, for example also by user input.

In a further step, the password is provided to a user of the second user terminal.

In this step, the password is transmitted or transferred to the user of the second user terminal. In particular, the user of the second user terminal is different from the user of the first user terminal and is the one who is to receive the second digital access key. In particular, the password is provided to the user via a separate communication channel, in particular a communication channel that is used in the context of the method according to the invention exclusively for the provision of the password and/or for no other transmission or provision, such as the provision of the encrypted password to the second user terminal, the provision of the encrypted password to a remote computing device and/or the provision of the encrypted password to the motor vehicle, as will be explained below.

In particular, the password is transmitted to the user of the second user terminal in plain text, human-readable form and/or unencrypted form. For example, the password is transmitted to the user of the second user terminal at the second user terminal, for example via an SMS, an e-mail, a voice call and/or as a push message in an app.

In particular, the user of the first user terminal may also communicate the password verbally to the user of the second user terminal, for example via a telephone call and/or because the users are in close proximity to each other. It is understood that this step of providing the password to the user of the second user terminal may also take place at a different time, in particular at a later time.

In a further step, the generated password is encrypted in the first user terminal.

The password is encrypted in the first user terminal and can be temporarily stored there for further processing. The encryption can be carried out with an asymmetric cryptosystem, which uses, for example, a key pair consisting of a private or secret key and a public key. In particular, the encryption can also be carried out with a hybrid encryption system that combines both asymmetric and symmetric encryption methods. In particular, the password can be encrypted based on elliptic curves, by using an ECIES, Elliptic Curve Integrated Encryption Scheme. A Diffie-Hellman method is used for the key exchange.

In a further step, the encrypted password is provided to the second user terminal.

The encrypted password can be transmitted via wireless data communication, such as mobile communications, in particular 3G, 4G, 5G, WiFi or WLAN, Bluetooth, NFC and/or RFID. In particular, the provision of the encrypted password to the second user terminal takes place via a communication channel other than that for the provision of the unencrypted password to the user of the second user terminal. The encrypted password can then be temporarily stored in the second user terminal for further processing.

A second digital access key for the motor vehicle is then generated in the second user terminal based on information from the first user terminal.

For this purpose, the first user terminal may have provided the second user terminal with data or information that can be used to generate a further such digital access key. This may include information relating to the vehicle, such as a unique identification number, such as a chassis number, a certificate and/or one or more keys, in particular a pair of keys.

This may have already taken place before the generation of the password and/or may include or represent a first, in particular initial, step of the method. This information may also be or has been transmitted via wireless data communication, as described above. This information was provided via the same communication channel as the encrypted password, but not the same communication channel as the password, to the user of the second user terminal.

Based on this information, a second digital access key for the motor vehicle is then generated in the second user terminal. In particular, the second digital access key is generated for the first time in this step. The digital access key can then be stored in the second user terminal, to give access to the vehicle. This is not or not yet carried out before or at the time of the generation of the second digital access key with the second user terminal. In particular, the second digital access key may be generated in the secure element of the second user terminal and/or stored there.

In a further step, the second digital access key and the encrypted password are provided to the motor vehicle.

The provision of the second digital access key serves to register and/or authorize the second user terminal in the motor vehicle. In particular, the second digital access key is also provided to unlock the motor vehicle.

In particular, the provision of the second digital access key together with the encrypted password is carried out for the first time, or for the first time after the generation of the second digital access key. In particular, the second digital access key may also be provided to the motor vehicle after this provision for the first time, but without the encrypted password. In particular, the encrypted password together with the second digital access key is only provided once and/or only until such time as the user of the second user terminal has entered the password correctly in the motor vehicle or until the password has been verified by the motor vehicle, as will be explained below.

Together with the second digital access key, further information and/or data may also be transmitted, for the first time and/or once, such as data that refer to and/or include the user of the first user terminal, the first digital access key and/or the first user terminal.

The provision is carried out in response to an approach of the second user terminal and/or of the user of the second user terminal to the motor vehicle. For example, the second user terminal is detected via wireless data communication, especially near-field communication, and the information will be provided later as described above. In particular, this may also be a communication channel other than the one via which the password was provided to the user of the second user terminal and/or via which the encrypted password was provided to the second user terminal.

The encrypted password is then decrypted in the motor vehicle.

This is carried out in the same way as encrypting the password, for example with an asymmetric cryptosystem, which, for example, uses a key pair of a private key or a secret key and a public key corresponding to the key pair of the encryption, and/or by a hybrid encryption system, which also combines both asymmetric and symmetric encryption methods for decryption, such as ECIES. The decrypted password can then be stored in the motor vehicle for further processing.

A password entry by the user of the second user terminal is then received in the motor vehicle.

The password entry can be used, for example, in an infotainment system, which can also be referred to as a human-machine interface and which has a hardware or software-based keyboard, one or more buttons and/or a touch screen. The password entry can also be entered as a voice input. The password entry includes the password that was provided or transmitted to the user of the second user terminal, in particular in plain text. A confirmation, such as an enter key or similar, can also be made.

The password entry is then compared with the decrypted password in the motor vehicle.

In this case, a character comparison is then carried out of the password entered by the user of the second user terminal with the previously decrypted password generated by the first user terminal and transmitted to the motor vehicle.

If the password entry matches the decrypted password, vehicle functions of the motor vehicle are then provided.

In particular, in response to the fact that the comparison is positive, i.e., the password entered and the decrypted password are the same, one or more vehicle functions are activated or enabled. In particular, the vehicle function involves starting an engine and/or deactivating an immobilizer.

The method according to the invention makes it possible to generate a further, second digital access key for the motor vehicle for a second user terminal in a particularly tamper-proof manner, starting from a first user terminal which already has a digital access key for a motor vehicle. In particular, the method according to the invention provides two-factor authentication for the key generation.

According to a development, the encryption of the password in the first user terminal is carried out based on a secret key of the first user terminal and a public key of the motor vehicle.

Thus, according to this development, an asymmetric and/or hybrid cryptosystem will be used, in particular ECIES, as described above. The password is encrypted using a secret or private key of the first user device and a public key of the motor vehicle.

In particular, the public key of the motor vehicle was previously provided by the motor vehicle to the first user terminal and/or was retrieved from the motor vehicle by the first user terminal or exchanged or agreed between them, in particular in the context of key generation of the first digital access key.

This development enables particularly safe and at the same time practical key generation.

According to a development, the decryption of the encrypted password is carried out in the motor vehicle based on a public key of the first user terminal and a secret key of the motor vehicle.

In particular, the public key of the first user terminal was previously provided to the motor vehicle by the first user terminal and/or retrieved by the motor vehicle from the first user terminal, or exchanged or agreed between them, in particular in the context of a key generation of the first digital access key.

This development also enables particularly safe and at the same time practical key generation.

According to a development, the provision of the encrypted password to the second user terminal is carried out by providing the encrypted password from the first user terminal to a remote computing device and providing the encrypted password from the remote computing device to the second user terminal.

Thus, according to this development, a remote computer device is used as an intermediate station. For this purpose, the encrypted password is first provided from the first user terminal to the remote computing device and then from the remote computing device to the second user terminal. This can be done in the context of key generation by the second user terminal and/or in response to a request of the second user terminal to the remote computing device.

A remote computing device is designed to be different from and spaced apart from the first user terminal, the second user terminal and the motor vehicle. The remote computing device can contain one or more servers, which are also partially or completely organized in the cloud. In particular, the remote computing device may be operated by a manufacturer of the motor vehicle and may be used, for example, for key management of one or more digital access keys.

The provision of the encrypted password from the first user terminal to the remote computing device and from the remote computing device to the second user terminal may involve transmission via wireless data communication, such as mobile communications, including 3G, 4G, 5G, WiFi or WLAN, Bluetooth, NFC and/or RFID, as described above.

In particular, the provision of the encrypted password from the first user terminal to the remote computing device and/or from the remote computing device to the second user terminal takes place via a communication channel other than that used for the provision of the unencrypted password to the user of the second user terminal.

The step of providing the encrypted password from the remote computing device to the second user terminal may have been preceded by a request from the second user terminal to provide the encrypted password.

This request may include a public key of the second user terminal, which can be used to determine or ascertain the affiliation of the encrypted password to the remote computing device. This public key of the second user terminal may have been previously provided to the remote computing device, by the first user terminal. In particular, the public key of the second user terminal may have previously been provided to the first user terminal and may have been provided by the first user terminal to the remote computing device. In particular, the public key was encrypted together with the password in or by the first user terminal and provided jointly to the remote computing device.

Alternatively or additionally, the request may include an in particular unique identification number of the second user terminal which can be used to determine or ascertain the affiliation of the encrypted password to the remote computing device. This identification number of the second user terminal may have been previously provided to the remote computing device, by the first user terminal. In particular, the identification number of the second user terminal may have been set or generated by the first user terminal and may have been provided to the remote computing device by the first user terminal. In particular, the public key was encrypted together with the password in or by the first user terminal and provided jointly to the remote computing device. Similarly, the identification number of the second user terminal may be provided from the first user terminal to the second user terminal, for example together with information for generating the second digital access key.

This development enables particularly secure key generation.

According to a development, the method also includes the steps of decrypting the encrypted password in the remote computing device and encrypting the decrypted password in the remote computing device.

According to this development, the encrypted password is decrypted in the remote computing device after it has been received from the first user terminal and is temporarily stored in the remote computing device, in unencrypted form. Before the decrypted password is provided by the remote computing device to the second user terminal, it is encrypted again.

Different key pairs can be used for decryption and encryption, especially different pairs of secret and public keys, as will be described in more detail below.

This development also enables particularly secure key generation.

According to a development, the encryption of the password in the first user terminal is carried out based on a secret key of the first user terminal and a public key of the remote computing device.

In particular, the public key of the remote computing device was previously provided by the remote computing device to the first user terminal and/or retrieved by the first user terminal from the remote computing device or exchanged or agreed between them.

This development also enables particularly secure key generation.

According to a development, the decryption of the password at the remote computing device is carried out based on a public key of the first user terminal and a secret key of the remote computing device.

In particular, the public key of the first user terminal was previously provided by the first user terminal to the remote computing device and/or retrieved by the remote computing device from the first user terminal, or exchanged or agreed between them.

This development also enables particularly secure key generation.

According to a development, the encryption of the decrypted password in the remote computing device is carried out based on a secret key of the remote computing device and a public key of the motor vehicle.

In particular, the public key of the motor vehicle was previously provided by the motor vehicle to the remote computing device and/or retrieved from the motor vehicle by the remote computing device or exchanged or agreed between them.

This development also enables particularly secure key generation.

According to a development, the decryption of the encrypted password in the motor vehicle is carried out based on a public key of the remote computing device and a secret key of the motor vehicle.

In particular, the public key of the remote computing device was previously provided to the motor vehicle by the remote computing device and/or retrieved by the motor vehicle from the remote computing device or exchanged or agreed between them.

This development also enables particularly secure key generation.

According to a further aspect, a device is specified which contains means to carry out or at least effect an embodiment of the method described above.

In particular, the device contains one or more processor devices for carrying out the method described above. In particular, the device also contains a memory, in particular non-volatile, in which code is stored which, when executed by a processor device, causes it to carry out the method described above.

In particular, the device may contain, form a system with and/or interact with the first user terminal, the second user terminal, the motor vehicle and/or the remote computing device to carry out the method described above.

Further features of the invention result from the claims, the FIGURE and the description of the FIGURE. The features and combinations of features mentioned above in the description as well as the features and combinations of features mentioned below in the description of the FIGURE and/or shown in the FIGURE alone can be used not only in the respective specified combination, but also in other combinations or on their own.

The invention is now explained in more detail by means of a preferred exemplary embodiment and with reference to the drawings. In the FIGURE:

### BRIEF DESCRIPTION OF THE DRAWINGS

FIG. 1 shows a schematic view of an embodiment of a method and a device for generating a digital access key for a motor vehicle.

### DETAILED DESCRIPTION OF THE DRAWINGS

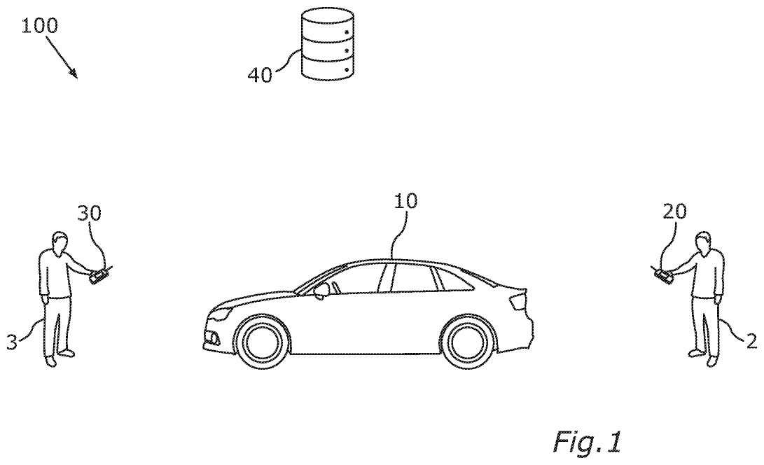

FIG. 1 shows a schematic view of an embodiment of a method and a device 100 for generating a digital access key for a motor vehicle 10.

The device 100 comprises the motor vehicle 10, a first user terminal 20 assigned to a first user 2 and a second user terminal 30 assigned to a second user 3. Optionally, the device also comprises the remote computing device 40. The device 100 is designed to carry out or at least effect the steps of the method described below.

The device 100 is designed to generate a password by means of the first user terminal 20, wherein the first user terminal 20 has a first digital access key for the motor vehicle 10.

The device 100 is also designed to provide the password to the user 3 of the second user terminal 30.

The device 100 is also designed to encrypt the password in the first user terminal 20.

The device 100 is also designed to provide the encrypted password to the second user terminal 30.

The device 100 is also designed to generate a second digital access key for the motor vehicle 10 in the second user terminal 30 based on information from the first user terminal 20.

The device 100 is also designed to provide the second digital access key and the encrypted password to the motor vehicle 10.

The device 100 is also designed to decrypt the encrypted password in the motor vehicle 10.

The device 100 is also designed to receive a password entry by the user 3 of the second user terminal 30 in the motor vehicle 10.

The device 100 is also designed to compare the password entry with the decrypted password in the motor vehicle 1.

The device 100 is also designed to provide vehicle functions in the motor vehicle 10 if the password entry matches the decrypted password.

The encryption of the password in the first user terminal 20 can be carried out based on a secret key of the first user terminal 20 and a public key of the motor vehicle 10 and the decryption of the encrypted password in the motor vehicle 10 can be carried out based on a public key of the first user terminal 20 and a secret key of the motor vehicle 10.

Alternatively or additionally, the provision of the encrypted password to the second user terminal may be carried out by providing the encrypted password from the first user terminal 20 to a remote computing device 40, decrypting the encrypted password in the remote computing device, encrypting the decrypted password in the remote computing device 40 and providing the encrypted password from the remote computing device 40 to the second user terminal 30.

The encryption of the password in the first user terminal 20 can be carried out based on a secret key of the first user terminal 20 and a public key of the remote computing device 40, the decryption of the password in the remote computing device 40 can be carried out based on a public key of the first user terminal 20 and a secret key of the remote computing device 40, the encryption of the decrypted password in the remote computing device 40 can be carried out based on a secret key of the remote computing device 40 and a public key of the motor vehicle 10 and the decryption of the encrypted password in the motor vehicle 10 can be caried out based on a public key of the remote computing device 40 and a secret key of the motor vehicle 10.

### LIST OF REFERENCE SIGNS

10 Motor vehicle
2 First user
20 First user terminal
3 Second user
30 Second user terminal
40 Remote computing device
100 Device

What is claimed is:

1. A method for generating a digital access key for a motor vehicle, the method comprising:
generating a password by a first user terminal, wherein the first user terminal has a first digital access key for the motor vehicle;
providing the password to a user of a second user terminal;
encrypting the password in the first user terminal;
providing the encrypted password to the second user terminal;
generating a second digital access key for the motor vehicle in the second user terminal based on information from the first user terminal;
providing the second digital access key and the encrypted password to the motor vehicle;
decrypting the encrypted password in the motor vehicle;
receiving a password entry by the user of the second user terminal in the motor vehicle;
comparing the password entry with the decrypted password in the motor vehicle; and
providing vehicle functions if the password entry matches the decrypted password.

2. The method according to claim 1, wherein the encrypting of the password in the first user terminal is carried out based on a secret key of the first user terminal and a public key of the motor vehicle.

3. The method according to claim 1, wherein the decrypting of the encrypted password is carried out in the motor vehicle based on a public key of the first user terminal and a secret key of the motor vehicle.

4. The method according to claim 1, wherein the providing of the encrypted password to the second user terminal is carried out by:
providing the encrypted password from the first user terminal to a remote computing device; and
providing the encrypted password from the remote computing device to the second user terminal.

5. The method according to claim 4, further comprising:
decrypting the encrypted password in the remote computing device; and
encrypting the decrypted password in the remote computing device.

6. The method according to claim 5, wherein the encrypting of the password in the first user terminal is carried out based on a secret key of the first user terminal and a public key of the remote computing device.

7. The method according to claim 5, wherein the decrypting of the password in the remote computing device is carried out based on a public key of the first user terminal and a secret key of the remote computing device.

8. The method according to claim 5, wherein the encrypting of the decrypted password is carried out in the remote computing device based on a secret key of the remote computing device and a public key of the motor vehicle.

9. The method according to claim 5, wherein the decrypting of the encrypted password is carried out in the motor vehicle based on a public key of the remote computing device and a secret key of the motor vehicle.

10. A device configured to generate a digital access key for a motor vehicle, wherein the device is configured to carry out a method according to claim 1.
